(19) United States
(12) Patent Application Publication
(10) Pub. No.: US 2010/0106871 A1
(43) Pub. Date: Apr. 29, 2010

(54) Native I/O system architecture virtualization solutions for blade servers

(76) Inventor: David A. Daniel, Scottsdale, AZ (US)

Correspondence Address: Law Office of ROBERT C. KLINGER, 2591 Dallas Parkway, Suite 300, FRISCO, TX, 75034, US

(21) Appl. No.: 12/587,780

(22) Filed: Oct. 13, 2009

Related U.S. Application Data
(60) Provisional application No. 61/195,864, filed on Oct. 10, 2008.

(51) Int. Cl. G06F 13/38

(52) U.S. Cl. 710/72

(57) ABSTRACT

A solution for blade server I/O expansion, where the chassis backplane does not route the blade's native I/O standard—typically PCI or PCI Express—to the I/O bays. The invention is a flexible expansion architecture that provides virtualization of the I/O system of the individual bade servers, via Gps or greater Ethernet routing via the backplane high-speed fabric of a blade server chassis. The invention leverages a proprietary i-PCI protocol.

### CLAIM OF PRIORITY

This application claims priority of U.S. Provisional Patent Application Ser. No. 61/195,864 entitled “NATIVE I/O SYSTEM ARCHITECTURE VIRTUALIZATION SOLUTIONS FOR BLADE SERVERS” filed Oct. 10, 2008, the teachings of which are incorporated herein by reference.

### FIELD OF THE INVENTION

The present invention relates to extension of a computer's native system bus via high speed data networking protocols, and specifically to techniques for blade server I/O expansion.

### BACKGROUND OF THE INVENTION

There is growing acceptance of techniques that leverage networked connectivity for extending and centralizing the resources of host computer systems. In particular, networked connectivity is being widely utilized for specialized applications such as attaching storage to computers. iSCSI makes use of TCP/IP as a transport for the SCSI parallel bus to enable low cost remote centralization of storage. The problem with iSCSI is it has a relatively narrow (storage) focus and capability.

Another trend is the move towards definition and virtualization of multiple computing machines within one host system. Virtualization is particularly well suited for blade server installations where the architecture is optimized for high density compute resources and pooled storage. The virtualization of CPU cycles, memory resources, storage, and network bandwidth allows for unprecedented mobility, flexibility, and adaptability of computing tasks.

PCI Express, as the successor to PCI bus, has moved to the forefront as the predominant local host bus for computer system motherboard architectures. A cabled version of PCI Express allows for high performance directly attached bus expansion via docks or expansion chassis. These docks and expansion chassis may be populated with any of the myriad of widely available PCI Express or PCI/PCI-X bus adapter cards. The adapter cards may be storage oriented (i.e. Fibre Channel, SCSI), video processing, audio processing, or any number of application specific Input/Output (I/O) functions. A limitation of PCI Express is that it is limited to direct attach expansion.

Gbps Ethernet is beginning to give way to 10 Gbps Ethernet. This significant increase in bandwidth enables unprecedented high performance applications via networks.

Referring to FIG. 1, a hardware/software system and method that collectively enables virtualization of the host bus computer's native I/O system architecture via the Internet, LANs, WANs, and WPANs is described in commonly assigned U.S. patent application Ser. No. 12/148,712, the teachings of which are incorporated herein by reference. The system described, designated “i-PCI”, is shown generally at 100 and achieves technical advantages as a hardware/software system and method that collectively enables virtualization of the host computer's native I/O system architecture via the Internet, LANs, WANs, and WPANs. The system includes a solution to the problems of the relatively narrow focus of iSCSI, the direct connect limitation of PCI Express.

This system 100 enables devices 101 native to the host computer native I/O system architecture 102,including bridges, I/O controllers, and a large variety of general purpose and specialty I/O cards, to be physically located remotely from the host computer, yet operatively appear to the host system and host system software as native system memory or I/O address mapped resources. The end result is a host computer system with unprecedented reach and flexibility through utilization of LANs, WANs, WPAN as and the Internet.

A significant problem with certain blade server architectures is that PCI Express is not easily accessible, thus, expansion is awkward, difficult, or costly. In such an architecture, the blade chassis backplane does not route PCI or PCI Express to the I/O module bays. An example of this type of architecture is the open blade server platforms supported by the Blade.org developer community: http://www.blade.org/aboutblade.cfm.

FIG. 2 shows the front view of a typical open blade chassis with multiple blades 201 installed. Each blade is plugged into a backplane that routes 1 Gbps Ethernet across a standard fabric, and optionally Fibre Channel, Infiniband, or 10 Gbs Ethernet across a high-speed fabric that interconnects the blade slots and the I/O bays.

FIG. 3 shows the rear view and the locations of the I/O bays 301 with unspecified I/O modules installed.

A primary advantage with blades over traditional rack mount servers is they allow very high-density installations. They are also optimized for networking and Storage Area Network (SAN) interfacing. However, there is a significant drawback inherent with blade architectures such as that supported by the blade.org community. Specifically, even though the blades themselves are PCI-based architectures, the chassis back plane does not route PCI or PCI Express to the I/O module bays. Since PCI and PCI Express are not routed on the back plane, the only way to add standard PCI functions is via an expansion unit that takes up a valuable blade slot, such as shown in FIG. 4. The expansion unit in this case adds only two card slots, and notabley, there is no provision for standard PCI Express adapters. It is an inflexible expansion, as it is physically connected and dedicated to a single blade.

### SUMMARY OF THE INVENTION

The invention achieves technical advantages by enabling the expansion of blade server capability using PCI Express or PCI-X adapter card functions to resources that may be located remotely. The invention makes it convenient to utilize standard adapter card form factors with blade servers.

In one embodiment, the invention provides virtualization of a blade server PCI I/O system utilizing a high speed adapter card configured to be coupled to the blade server, the high speed blade server chassis fabric, 10 Gbps or greater Ethernet, and a Remote Bus Adapter.

The invention is a solution for blade server 1/0 expansion, where the blade server chassis backplane fabric does not route PCI or PCI Express to the I/O bays. The invention is a unique flexible expansion architecture that utilizes virtualization of the PCI I/O system of the individual bade servers, via Gps or greater Ethernet routing across the backplane high-speed fabric of a blade server chassis. The invention leverages the applicant's proprietary i-PCI protocol as the virtualization protocol.

The invention achieves unprecedented expansion capability and I/O configuration capability for blade servers. It uniquely leverages the fabric inherent to blade chassis designs to achieve I/O expansion without any physical modification to the blade chassis itself. Thus, the invention also achieves the advantage of requiring no changes to the present blade standards. The net result is elimination of one of the key downsides of the blade server form factor in comparison to free-standing or standard rackmount servers, that being very limited and restrictive I/O capability of blade servers.

### BRIEF DESCRIPTION OF THE DRAWINGS

FIG. 1 depicts using the Internet as a means for extending a computer system's native bus via high speed networking;

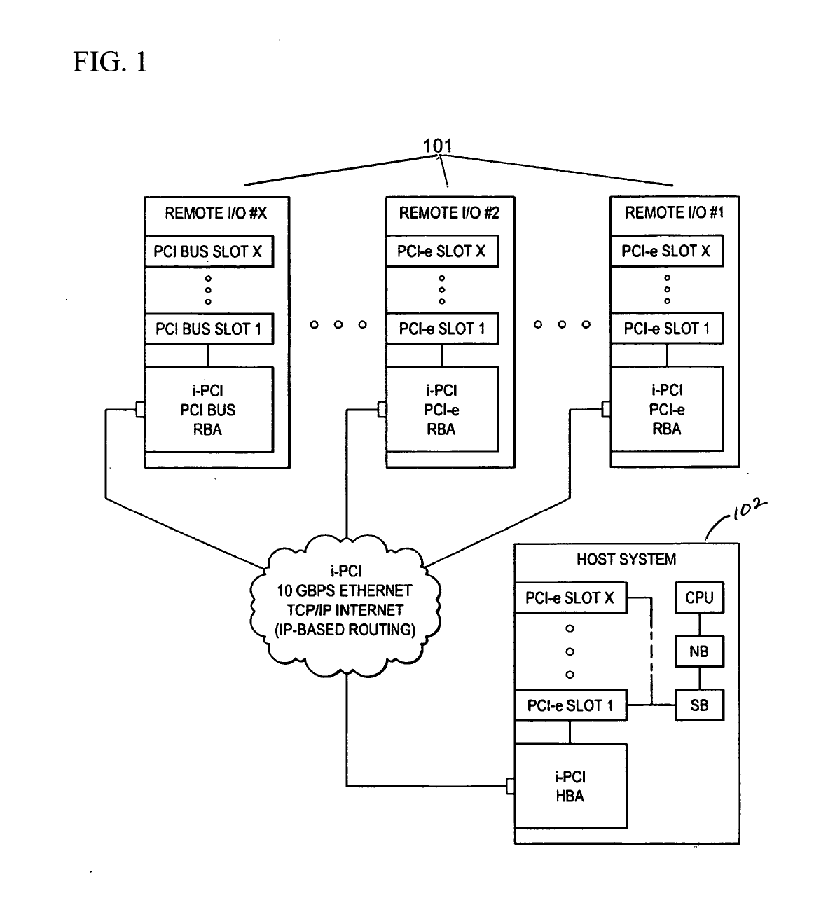

FIG. 2 depicts the front view of a typical open blade chassis with multiple blades installed.

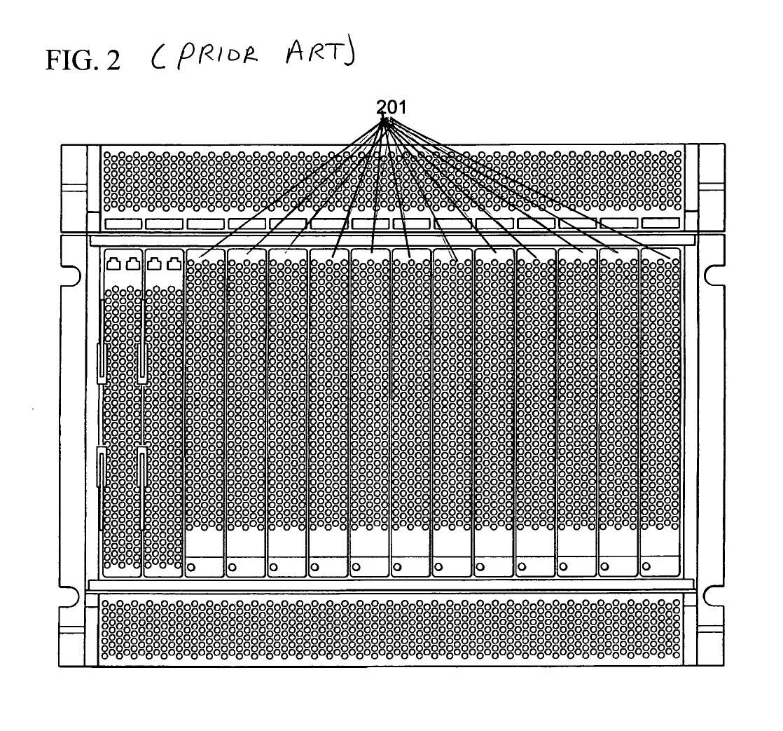

FIG. 3 depicts the rear view of a typical open blade chassis;

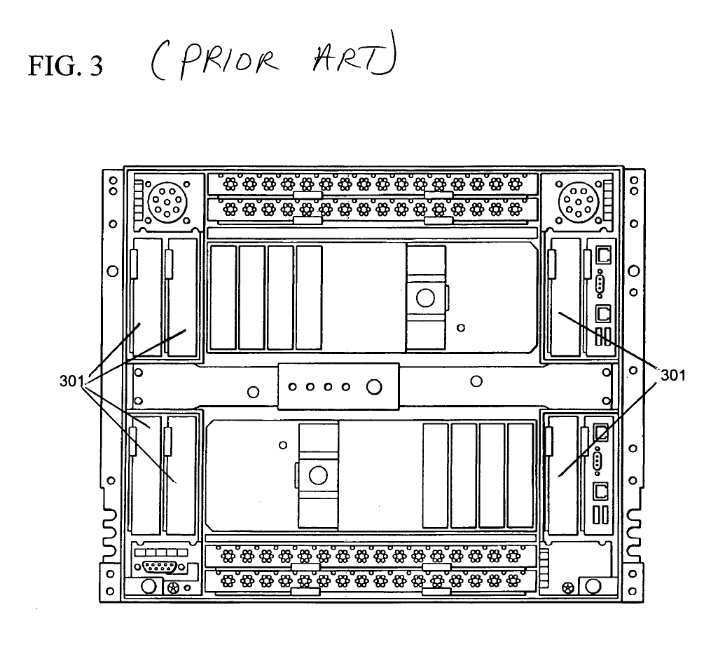

FIG. 4 depicts an open blade PCI Expansion Unit;

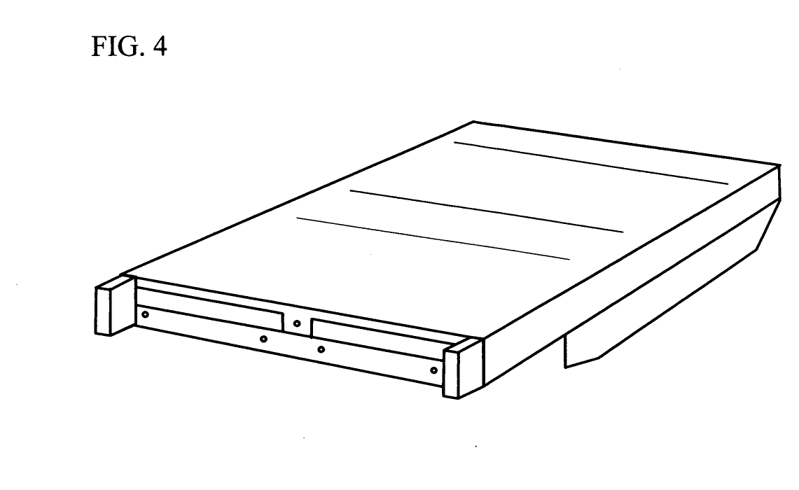

FIG. 5 depicts the key components of one solution that allows blades access to standard PCI Express Adapter functions via memory-mapped I/O virtualization;

FIG. 6 shows the major functional blocks of a High Speed Adapter (HAC) card;

FIG. 7 shows the major functional blocks of a Remote Bus Adapter (RBA);

FIG. 8 shows a PCI-to-network address mapping table to facilitate address translation; and

FIG. 9 shows the major functional blocks of the Resource Cache Reflector/Mapper.

### DETAILED DESCRIPTION OF THE PRESENT INVENTION

It is very desirable and convenient for a user to have the option of expanding blade capability using PCI Express or PCI-X adapter card functions as resources that can be memory-mapped to any of the blade servers installed in the open server chassis. It is optimal to utilize the I/O bays for expansion, as intended, rather than taking up a blade server slot for expansion. The invention is a flexible expansion configuration that accomplishes this capability through virtualization of the PCI I/O system of the individual blade servers. The invention virtualizes the PCI I/O system via 10 Gbps Ethernet routing across the backplane high-speed fabric of the open blade server chassis. The invention allows blades access to standard PCI Express adapter functions via memory mapped I/O virtualization. The adapter functions can include PCI Express Fibre Channel SAN cards that were intended for use with traditional servers. For the first time, adapter functions are convenient to open blades including the many functions that are available in the standard PCI-X or PCI Express adapter card form factors. Even specialized functions such as those implemented in industrial PCI form factors become part of a solution set. This opens the possibility of utilizing the blade architecture for applications other than enterprise data centers. These functions can be flexibly and freely assigned/re-assigned to the various blades, as determined by the user.

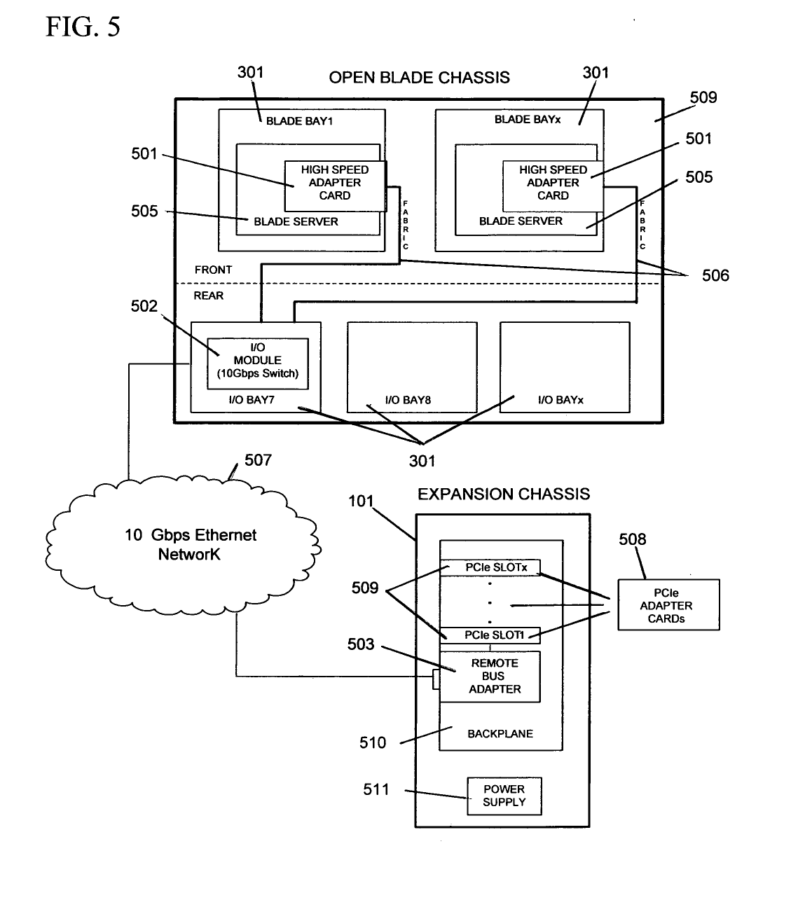

Referring to FIG. 5 there is shown a Virtualization Solution System Diagram at 500, including the key components of the system as the High-Speed Adapter Card (HAC) 501, a 10 Gbps Switch Module 502, a Remote Bus Adapter (RBA) 503, and an Expansion Chassis 101.

In applicant's commonly assigned U.S. patent application Ser. No. 12/148,712 the i-PCI protocol is introduced. It describes a hardware, software, and firmware architecture that collectively enables virtualization of host memory-mapped I/O systems. Advantageously the i-PCI protocol extends the PCI I/O System via encapsulation of PCI Express packets within network routing and transport layers and Ethernet packets and then utilizes the network as a transport. For further in-depth discussion of the i-PCI protocol see U.S. patent application Ser. No. 12/148,712, the teachings which are incorporated by reference.

In the case of blade servers 505, the 10 Gbps network running across the blade chassis backplane high-speed fabric 506 is made transparent to the blade, and thus PCI Express functions located in the expansion chassis appear to the host system as an integral part of the blade's PCI system architecture. The expansion chassis 101 may be located in close proximity to the open blade server chassis, or anywhere it might be convenient on the Ethernet network 507.

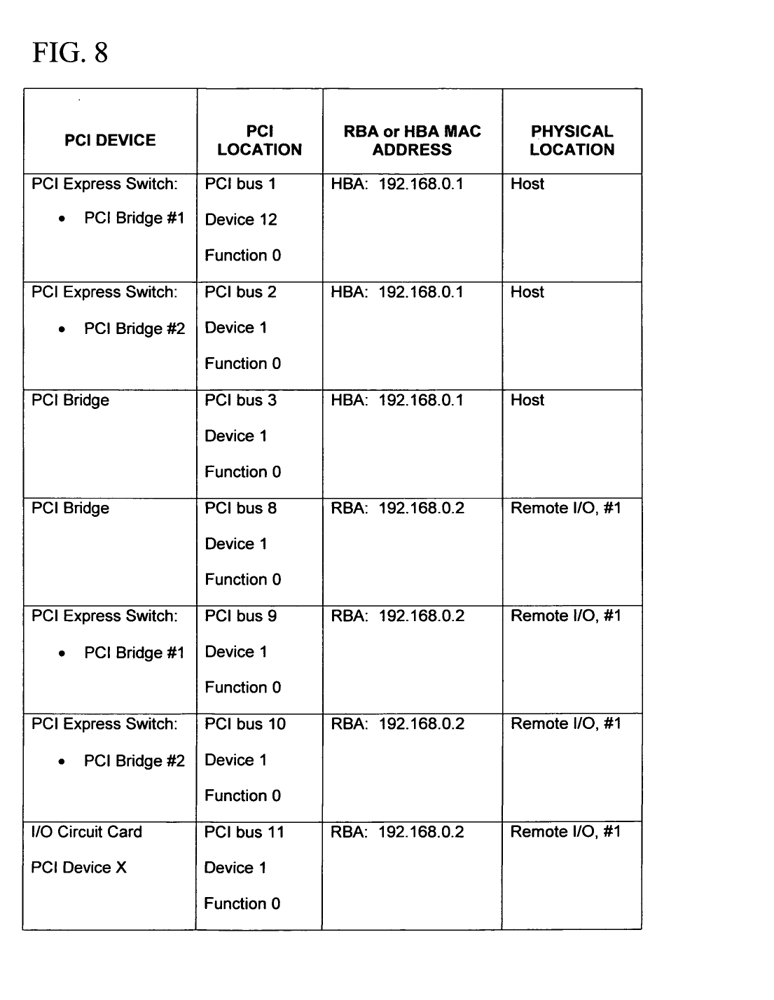

The HAC 501 advantageously mounts as a daughter card to the standard blade servers 505 that implement a PCI Express mezzanine connector. The HAC is a critical component. First and foremost, it provides the physical interface to the backplane high speed fabric 506. In addition, many of the necessary i-PCI functional details are implemented in the HAC such as PCI Express packet encapsulation. It is the HAC resident functions (supported by functions in the Remote Bus Adapter located in the expansion chassis) that are responsible for ensuring PCI System transparency. The HAC 501 ensures that the blade server remains unaware that remote I/O is not directly attached to the blade server. The HAC responds and interacts with the blade PCI system enumeration and configuration system startup process to ensure remote resources in the expansion chassis are reflected locally at the blade and memory and I/O windows are assigned accurately. The HAC performs address translation from the system memory map to a network address and then back to a memory-mapped address as a packet moves between the blade and the expansion chassis. The HAC includes a PCI-to-network address mapping table to facilitate address translation. FIG. 8 shows the configuration of such a table.

Virtualization of the host PCI system introduces additional latency. This introduced latency can create conditions that result in assorted timeout mechanisms including (but not limited to) PCI system timeouts, intentional driver timeouts, unintentional driver timeouts, intentional application timeouts, and unintentional application timeouts. Advantageously, the HAC handles system timeouts that occur as a result of the additional introduced latency to ensure the expansion runs smoothly.

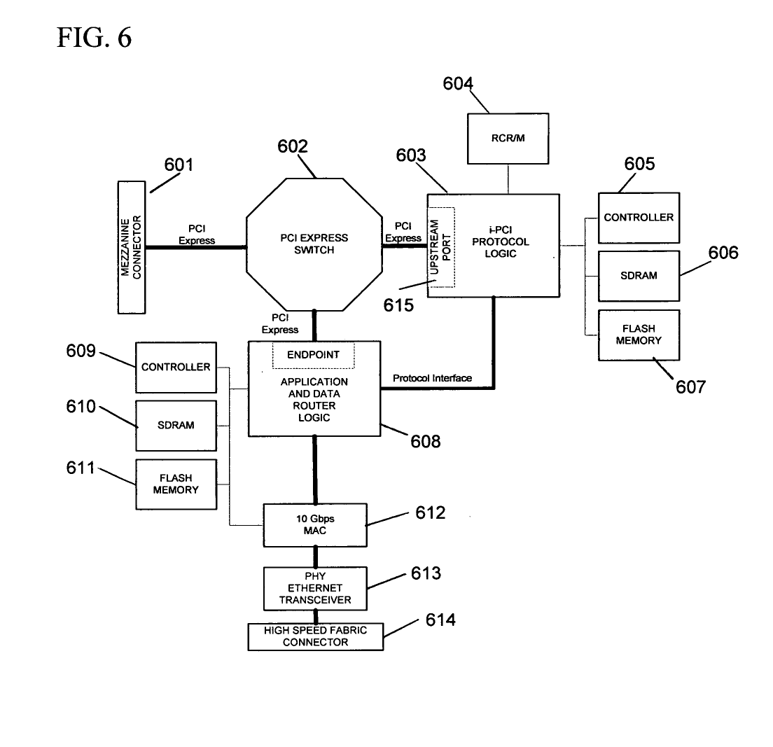

The HAC major functional blocks are depicted in FIG. 6. The HAC design includes a Mezzanine interface connector 601, a PCI Express Switch 602, i-PCI Protocol Logic 603, the Resource Cache Reflector/Mapper 604, Controller 605, SDRAM 606 and Flash memory 607 to configure and control the i-PCI Protocol Logic, Application and Data Router Logic 608, Controller 609, SDRAM 610 and Flash memory 611 to configure and control the Application and Data Router Logic and 10 Gbps MAC 612, PHY 613, and the High Speed Fabric Connector 614.

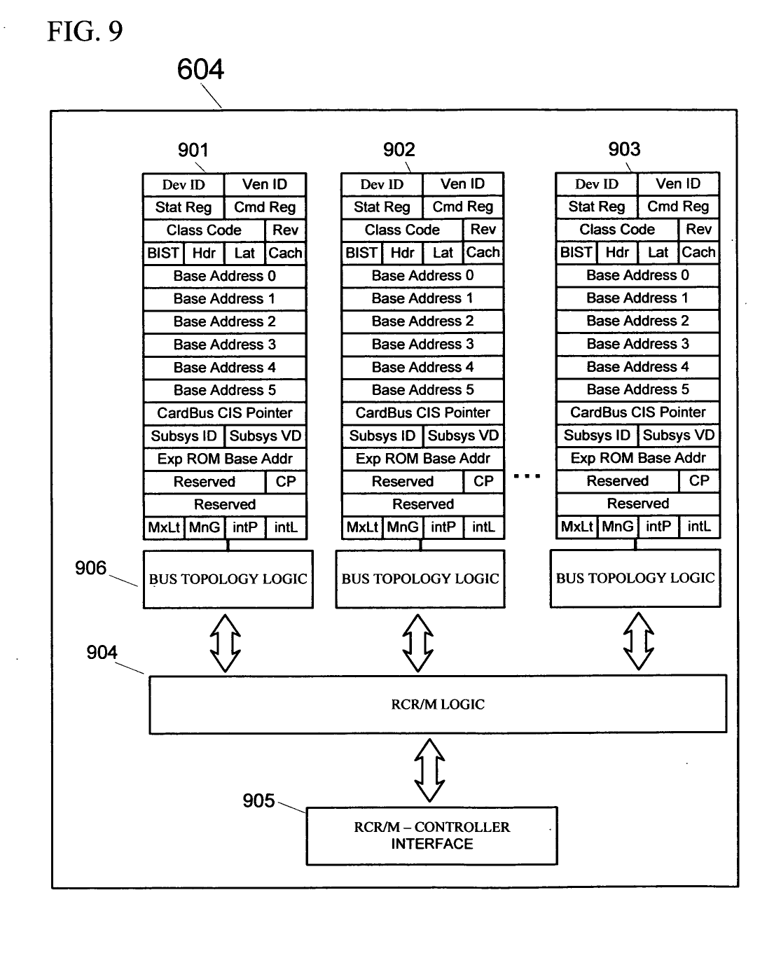

Referring to FIG. 9, the RCR/M 604 is resident in logic and nonvolatile read/write memory on the HAC. The RCR/M consists of an interface 905 to the i-PCI Protocol Logic 603 configured for accessing configuration data structures. The data structures 901, 902, 903 contain entries representing remote PCI bridges and PCI device configuration registers and bus segment topologies 906. These data structures are pre-programmed via an application utility. Following a reboot, during enumeration the blade BIOS “discovers” these entries, interprets these logically as the configuration space associated with actual local devices, and thus assigns the proper resources to the mirror.

The HAC 501 and Remote Bus Adapter (RBA) 503 together form a virtualized PCI Express switch. The invention of a virtualized switch is further disclosed in U.S. patent application Ser. No. 12/148,712 andentitled “Virtualization of a Host Computer's Native I/O System Architecture via the Internet and LANs”, and in US Patent Application Publication US 2007/0198763 A1.

Each port of the virtualized switch can be located physically separate. In the case of a blade implementation, the HAC installed on a blade implements the upstream port 615 via a logic device, such as a FPGA. The RBAs, located at up to 32 separate expansion chassis 101, may include a similar logic device onboard with each of them implementing a corresponding downstream port 714. The upstream and downstream ports are interconnected via the high speed fabric 506, I/O module 502, and the Ethernet network 507, forming a virtualized PCI Express switch.

The Ethernet network 507 may optionally be any direct connect, LAN, WAN, or WPAN arrangement as defined by i-PCI.

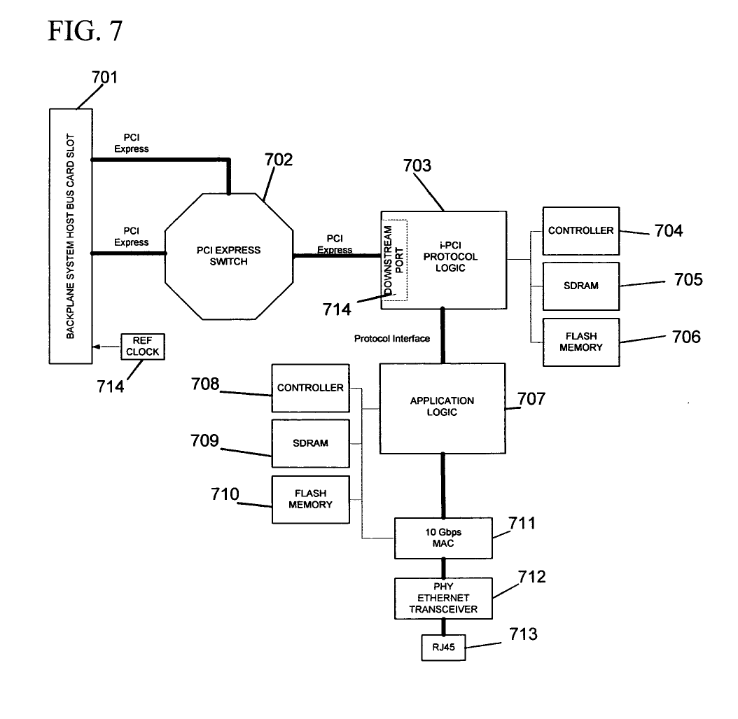

Referring to FIG. 7, the RBA 503 is functionally similar to the HAC 501. The primary function of the RBA is to provide the expansion chassis with the necessary number of PCI Express links to the PCI Express card slots 509 and a physical interface to the Ethernet network 507. PCI Express packet encapsulation for the functions in the expansion chassis is implemented on the RBA. The RBA supports the HAC in ensuring the blade remains unaware that the PCI and/or PCI Express adapter cards 508 and functions in the expansion chassis are not directly attached. The RBA assists the HAC with the blade PCI system enumeration and configuration system startup process. The RBA performs address translation for the PCI and/or PCI Express functions in the expansion chassis, translating transactions moving back and forth between the blade and the expansion chassis via the network. It also includes a PCI-to-network address-mapping table. See FIG. 8. Data buffering and queuing is also implemented in the RBA to facilitate flow control at the interface between the Expansion Chassis PCI Express links and the network. The RBA provides the necessary PCI Express signaling for each link to each slot in the expansion chassis.

The RBA major functional blocks are depicted in FIG. 6, i-PCI RBA. The RBA design includes a Backplane System Host Bus interface 701, a PCI Express Switch 702, i-PCI Protocol Logic 703; Controller 704, SDRAM 705 and Flash memory 706 to configure and control the i-PCI Protocol Logic; Application Logic 707; Controller 708, SDRAM 709 and Flash memory 710 to configure and control the Application Logic and 10 Gbps MAC 711; PHY 712, and connection to the Ethernet 713.

The 10 Gbps I/O Module Switch in the open blade chassis may be an industry standard design, or a high performance “Terabit Ethernet” switch design based on switching design disclosed in commonly assigned U.S. patent application Ser. No. 12/148,708 entitled “Time-Space Carrier Sense Multiple Access”. In Ethernet applications, a standard Ethernet switch routes data packets to a particular network segment, based on the destination address in the packet header. A Multi-stage Interconnect Network (MIN) within the switch interconnects the network segments. In a Terabit Ethernet switch, carrier sensing is used to establish a path through a MIN. The technique utilizes spatial switching, in addition to temporal switching, to determine the data path. The end result is a high performance low latency switch design well suited for blade applications.

The expansion chassis 101 is a configurable assembly to house the RBA 503, a passive backplane 510, power 511, and assorted PCI or PCI Express adapter cards 508. In one preferred embodiment, the passive backplane is a server-class PICMG-compatible backplane. Common PCI and PCI Express adapter card functions, as well as legacy storage-oriented adapter card functions such as Fibre Channel cards, may populate the expansion chassis. The expansion chassis could be located in close proximity to the open blade chassis or anywhere there is network connectivity, as convenient. Expansion chassis do not require a local host; the RBA provides the network connectivity. Since the PCI Express Specification allows up to 256 links in a root port hierarchy, a very large expansion system for blades is possible.

Though the invention has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

What is claimed is:

1. A system configured to enable virtualization of a native I/O subsystem of a blade server connectable to a blade chassis backplane fabric, the blade server configured to exchange data based on a native I/O standard, comprising:
an adapter card operably compatible with the blade server native I/O standard and having an interface configured to couple to the backplane fabric, the adapter card configured to encapsulate/un-encapsulate the blade server data according to a protocol;
an Ethernet switch module configured to interface the blade server data on the backplane fabric to an external network;
a remote bus adapter configured to encapsulate/un-encapsulate the data to/from the external network, respectively, and interface the data to a passive backplane based on the same I/O standard as the blade server native I/O standard, wherein the passive backplane is configured to host a plurality of I/O adapter cards.

2. The mechanism as specified in claim 1 whereas the blade server native I/O standard is PCI-X or PCI Express.

3. The system as specified in claim 1 where the external network is selected from the group: direct connect, LAN, WAN, or WPAN.

4. The system as specified in claim 1 where the passive backplane is a server-class PICMG-compatible backplane.

5. The system as specified in claim 1 wherein the adapter card is configured to physically couple to the blade server.

6. The system as specified in claim 5 wherein the Ethernet switch module is configured to physically couple to the blade chassis backplane fabric.

7. The system as specified in claim 6 wherein the Ethernet switch module is configured to switch the blade server data with a plurality of the adapter cards.

8. The system as specified in claim 1 wherein the protocol is based on memory mapping.

9. The system as specified in claim 1 wherein the Ethernet switch module is configured to physically couple to the backplane fabric in an I/O bay of the blade chassis.

10. The system as specified in claim 2 wherein the adapter card is configured to manage any introduced latency that can create conditions that result in assorted timeout mechanisms including PCI system timeouts, intentional driver timeouts, unintentional driver timeouts, intentional application timeouts, and unintentional application timeouts.

11. An adapter card configured to enable virtualization of a native I/O subsystem of a blade server connectable to a blade chassis backplane fabric, the blade server configured to exchange data based on a native I/O standard, the adapter configured to be operably compatible with the blade server native I/O standard and having an interface configured to couple to the backplane fabric, the adapter card configured to encapsulate/un-encapsulate the blade server data according to a protocol, and interface the data to an external network.

12. The adapter card as specified in claim 11 wherein the external network is selected from the group of: direct connect, LAN, WAN, or WPAN.

13. The adapter card as specified in claim 11 wherein the adapter card is configured to physically couple to the blade server.

14. The adapter card as specified in claim 11 wherein the protocol is based on memory mapping.

15. The adapter card as specified in claim 12 wherein the adapter card is configured to manage any introduced latency that can create conditions that result in assorted timeout mechanisms including PCI system timeouts, intentional driver timeouts, unintentional driver timeouts, intentional application timeouts, and unintentional application timeouts.

16. The adapter card as specified in claim 15 wherein the adapter card is configured to expand the blade server data to an expansion module physically remote from the blade chassis.

17. The adapter card as specified in claim 16 wherein the expansion module is coupled to passive backplane based on the same I/O standard as the blade server native I/O standard, wherein the passive backplane is configured to host a plurality of I/O adapter cards.
